(19) United States
(12) Patent Application Publication
(10) Pub. No.: US 2026/0368367 A1
(43) Pub. Date: Nov. 19, 2026

(54) System for Crowdsourced Data Collection, Decentralized Governance, Crypto-economic Incentives, and Information Tokenization

(71) Applicants: Douglas John Buettner, West Haven, UT (US); Brandon Michael Pendleton, Sequatchie, TN (US); David Coy, Florence, OR (US)

(72) Inventors: Douglas John Buettner, West Haven, UT (US); Brandon Michael Pendleton, Sequatchie, TN (US); David Coy, Florence, OR (US)

(21) Appl. No.: 19/755,692

(22) Filed: Jul. 27, 2026

Related U.S. Application Data
(63) Continuation-in-part of application No. 18/812,943, filed on Aug. 22, 2024.

(51) Int. Cl. G06F 21/64; G06T 7/20; H04L 9/00; H04L 9/32

(52) U.S. Cl. CPC G06F 21/64; G06T 7/20; H04L 9/3213; H04L 9/3247; H04L 9/50; H04L 2209/56

(57) ABSTRACT

This invention presents a system for capturing, validating, and tokenizing crowdsourced data from user devices, with an exemplary focus on Unidentified Anomalous Phenomena (UAP) sightings, but extendable to other real-time data collection scenarios. The system uses blockchain technology to ensure data validation and immutability, and AI/ML and statistical image/data recognition algorithms for real-time data analysis. It incorporates a crypto-economic reward system in which contributors receive information tokens whose value is dynamically determined by the accuracy and relevance of the validated data. A decentralized autonomous organization (DAO) governs the platform, allowing token holders to participate in decision-making regarding system improvements, data validation criteria, and token rewards. The invention facilitates improved data integrity, user anonymity, and community-driven governance while addressing the challenges of decentralized crowdsourcing.

### CROSS-REFERENCE TO A RELATED APPLICATION

The present application is a continuation-in-part of U.S. patent application Ser. No. 18/812,943 filed Aug. 22, 2024.

### BACKGROUND OF THE INVENTION

### Field of the Invention

In times such as these, with unpredictable world events, unknown risks, unrealized dangers, and strange occurrences, a reporting and predictive event modeling system is useful for education and community engagement for any number of reasons, including safety and security. In all such cases, there is a need for real-time, unbiased data contributions from the public at large, with anonymity to protect both the data and the contributor.

The present invention generally relates to crowdsourced notification and information-sharing systems, and such systems that are specifically suited to capturing observational data associated with the real-time world and human events such as, but not limited to, airborne object sightings, including unknown or unidentified aerial phenomena sightings; or even impactful environmental changes; crime; traffic patterns and flow; disease outbreak and propagation; fluctuation and supportive infrastructure demands in civilization and communities; crowd monitoring and control; medical emergency alerting; augmented reality amusement and entertainment; and of course, national security and defense; and issuing fungible tokens in response to the crowdsourced submissions associated therewith.

More particularly, the claimed invention is directed to the systems mentioned above incorporating a crowdsourced data gathering function using an open network distributed platform enabling a plurality of anonymous users, potentially unlimited in number, to contribute sighting event information data related to the observable events associated with airborne objects and anomalies including Unidentified Anomalous Phenomena (UAP) and the like.

Moreover, there is an increasing trend for platforms that can handle real-time, crowdsourced data in areas such as UAP sightings, environmental monitoring, and other critical observations, and that can assess the authenticity (credibility) of the data and assign a commensurate value through metric-driven assessment. The current systems comprising the background art seem unable to effectively incentivize users to contribute high-quality data, ensure data integrity, or “tokenize” data value based on its relevance and accuracy.

This invention solves these problems by introducing a decentralized system that not only collects crowdsourced data from users' devices but also accesses independent 3^{rd} party data to validate and tokenize it based on its informational value, using comparative algorithms, accessible smart (AI) databases, and the frequency of historical event similarity, to name a few. In short, the data's relevance for improving the accuracy of the adjoined submissions increases the value of the information tokens that users receive or hold. Thus, the present invention is intended to issue fungible tokens (tokenization), wherein the valuation is determined by event-relevance factors, data inputs, and mining, such as the similarity of previously recorded submissions, adjoined by location, time, and look-angle direction and elevation above the horizon, to name a few. In addition, the archiving and retrieval of legacy data must be dynamic, so that it is easily accessible as current-event data, enabling real-time comparisons and contrasts, but more particularly, token valuation dynamically in real time.

The present invention is believed to have a direct correlation with the safety and security of the citizenry of the nation and community in which such capability is installed and utilized, while incentivizing activism in those areas through reward-based recognition (i.e., tokens and tokenization).

### Description of the Related Art

Using UAP sightings as an example, many people are interested in UAPs and actively study or analyze reports of sighting events. Sometimes, UAP sighting data is inconsistent or unreliable, and upon which a collective understanding, albeit scientific, is needed, or when a response may need to be formulated or initiated, as is the case for emergency or national security-related situations. The lack of consistent and reliable information may be due to a range of factors, for example, a lack of source device authentication and metadata, uncooperative versus cooperative disclosures, variability in reporting, limited research resources, lack of anonymity, an inability to verify an event observed from separate locations simultaneously, improper characterization of the observed event, data capture device shortcomings, and a lack of relational data support. Such factors also contribute to an incomplete record of the sightings and, hence, to the data's minimal utility due to its anecdotal nature.

Currently, there are no known formal systems for UAP sighting data that incorporate crowdsourced, open-network data, independent access to third-party data, and are coordinated by a central platform for distributed and decentralized data capture and processing to automatically reduce prosaic mundane objects from being reported in the first place, that also supports tokenization, which promotes system utilization, integrity, and longevity and 3^{rd} party relational database access and inputs.

For example, the known relevant background art comprises U.S. Pat. No. 12,468,754 granted to Randall, and U.S. Pat. No. 11,037,024 granted to Ratti, both of which are incorporated herein by this reference as if fully set forth herein. The Randall and Ratti systems differ from the family of inventions to which this disclosure relates because the authentication engines of those background systems lack decentralized processing and tokenization, unlike the present invention(s).

The background systems also lack an invitation notification feature that alerts member subscriber devices on the open network, at rest in passive mode, to “wake up” and look for a potential observational event in their region. Thus, the background devices and their networks are also incapable of utilizing a plurality of on-demand sensor (data) inputs that expand in number in real-time to ensure that data integrity increases as the number of inputs and their corresponding data sources dynamically increase, thereby minimizing the stochastic randomness of the AI model for data collected.

The background art also uses fundamental feedback to verify data transmission and collection, rather than authenticity, so that the dynamically expanding group becomes more arbitrary in real time, whereas the present invention enhances the reliability of the data associated with the event, such as a UAP sighting. The ineffectiveness of the background systems can be associated with ineffective mechanisms to discriminate, authenticate, compare, access third party data, and assess the value of captured observational data against relational data sets, and to create identification signatures for future reference and to enhance platform performance over time, thereby driving the AI genius of the output.

Several other US and international patent applications are directed to real-time environmental monitoring systems that use cameras and purported AI to analyze static environments, such as warehouses and buildings, all of which can be described as surveillance. Their purpose is to monitor a static environment for changes in a known set of static data for security purposes. Those systems, and the background systems like them, do not use a crowdsourced, open network with potentially unlimited numbers of users, dynamic fluctuations in data inputs, and distributed processing resources across the network, all of which are useful for handling the dynamic data associated with changing events such as moving targets (UAP subjects). Moreover, such background systems cannot provide a consistently reliable predictive model because of mundane objects. In addition, many of those platforms' allocation (or limitation) of central processing resources lacks the distributed processing capabilities found in today's mobile devices.

Therefore, such background systems are known to report without a preprocessed distributed early assessment (verification, authentication, comparison, correlation, or identification, etc.), such that any feedback, including tokenization if it were one day incorporated therewith, is limited to predictable trend analysis and ignores other learning functions associated with unpredictable feedback where artificial intelligence (AI) and machine learning (ML) are considered useful as part of the present invention, especially token valuation, whenever unexplainable aerial movements are observed, including true UAPs for which little is known.

Until now, a platform for using crowdsourced data captured in an open (as to user participation), secure network with a distributed architecture having a virtually unlimited number of users as participants, wherein the network is designed for anonymity of the user while capturing the input data, accessing independent 3^{rd} party relational databases for data verification and/or authentication increasing data integrity and promoting real-time correlation with previously observed and recorded events, while enabling threat assessment, and issuing crypto-economic token rewards as the metric that drives value, has not been invented in the manner disclosed and described herein.

In addition, the plurality of distributed processing in today's devices, and a feature of the present invention, enables capturing and preprocessing the observational data by users, each with various levels of sophistication, where less capable devices can leverage more capable devices through user concurrence in support of the identification platform itself through the tokenization of and allowance of processing on the user's more capable device. None of these capabilities are found in the background art.

For example, there is a need for a system to uniformly collect data associated with UAP sightings for national security and defense, to access independent third-party relational databases, and to issue tokens to properly incentivize and compensate the data submitter, enabling automatic news and reporting, such as early warning and anonymized whistleblower reporting (e.g., during civil unrest and emergency situations). The system associated with the present invention enables a faster, more targeted response to previously unknown threats, including the capability to initiate appropriate responses to observable aerial events associated with unknown (unidentified) sources, while incentivizing participation through tokenization.

### SUMMARY OF THE INVENTION

The following summary of the invention is presented in a simplified form as a prelude to the description and related discussion presented below.

The invention uses anonymous crowdsourcing, comprising multi-sensor (user) inputs and user input integration, real-time data processing, and AI and ML algorithms to optimize feedback in general and patterned responses in particular. System data processing is facilitated by integration with the system's inherent databases and optional relational databases from the private, governmental, research, and industrial sectors. Real-time notifications based on changes in observable or perceived data conditions (events), such as location, velocity, frequency, intermittence, and unknown-object probability, trigger the system to notify other network subscribers (triggering instructions), encouraging their participation in data capture. The user inputs (data captured) may be augmented by auxiliary or additional device inputs, such as but not limited to radar, external cameras using various spectral wavelengths, including IR and UV, lidar, and sophisticated independent monitoring systems, to increase confidence in the data and feedback.

In one general aspect, the present invention addresses the significant challenges associated with collecting consistent and reliable eyewitness data on UAP occurrences due to variability in device capabilities, inconsistent correlation to the data associated with the observable event, an inability to corroborate (discriminate, authenticate, or verify) the data collected, access additional resources, and assign relative value to the event data input, to name a few.

The significance of the crowdsourcing function lies not only in providing variability in perspective on, for example, the observer's location relative to the target (e.g., UAP), but also in serving a contributory role for accurate observation, predictability, trend analysis, and extrapolation to corresponding unpredictable events. This analysis also promotes a responsive capability, including responses to events, in which data assessment uses artificial intelligence (AI) and machine learning (ML) algorithms to generate meaningful (useful) reporting needed for appropriate responses. The usefulness of the reports and associated value-driven tokens directly correlates with the responsiveness of independent systems initiated by the inventive system, such as in the national security and defense category, as well as in the educational or amusement arts for hobbyists. The report (feedback) enables the network operators and those in a managerial capacity of the processing platform, residents in a single location using resources such as cloud-based computing or distributed amongst the user devices such as a smartphone application (app), to become better informed and educated regarding true anomalous event expectations, enabling an initiative-taking approach (triggering) that will benefit society as a whole by educating the public on the appearance of mundane objects and UAP alike.

In addition, the invention is a secure, open, crowdsourced network with the potential for unlimited contributors. A contributor may be anyone who provides event data such as additional metadata; photos; movies; scientific data; such as but not limited to unique spectral, radar, lidar, or audio data; relational context; subject matter expertise towards data validity assessments; and data processing. The network further includes a notification or call-to-alert feedback component (hereafter, triggering instructions) to strengthen the consistency and reliability of the data captured, and addressing the shortcomings of the background devices as stated above.

Enhanced participation enables a better correlation between data inputs and the coordination of independent relational databases across all contexts (examples include aircraft, satellites, planetary objects, unmanned aerial vehicles, weather phenomena, balloons, and sky lantern likelihood, among others). It provides a sense of personal satisfaction in engaging with each person who shares the growing interest and concern not only for themselves but also for all to be aware of the associated world event.

In general, the platform on which the present invention will be shared and used is a handheld communication device such as a handheld smartphone, tablet or properly configured computer with the appropriate peripherals enabling the needed data capture and distribution functionality, peer-to-peer inter-device coordination or interactively connecting to a platform for centralized coordination of the decentralized processing, or managed shared processing depending upon such factors as the sophistication of the user device and the associated capabilities of it.

For example, it is conceivable that one may utilize a handheld smartphone just as easily as an individual would use a stationary desktop computer with peripherals such as a camera with a directional capability, such that two or more devices may be aimed at the event to capture images, sounds, other metadata such as but not limited to location, time and look angle with elevation angle to provide device-resident processing for efficiency of the securely connected platform open on the web. In other cases, where the user device (transceiver) can capture and transmit data (e.g., legacy cellphones with simple cameras) but lacks sufficient processing capability to meet the platform's data processing requirements, the platform-resident processing performs the tasks it can and provides the information to the peer-to-peer device or the centralized coordination server to identify a suitable distributed processing mechanism. In situations where users allow their devices to process data from less capable devices, the system can assign a percentage or stake in token issuance for the authentication or identification of prosaic objects, depending on the ancillary processor's involvement.

An aspect of the invention relies on variances in user device architecture. The system uses data collected from many potential user devices, categorized by their capabilities, modes of operation, and technology versions. Thus, the invention can be described as a decentralized platform for collecting, validating, and tokenizing crowdsourced data, particularly focused on UAP sightings but extendable to other real-time data-collection applications. The system leverages multi-sensor data captured from user devices and uses blockchain technology with encryption to validate data and ensure integrity, while providing a method for tokenization and historical tracking of the data validation processes accomplished to date.

For example, human-operated user devices include handheld communication devices, such as smartphones or tablets, equipped with multiple sensors, including GPS, cameras of all types, accelerometers, gyroscopes, and a multitude of potential peripherals, to capture multimedia and metadata related to UAP sightings or similar real-time events. Machine-operated user devices include specialized autonomous sensors, such as radar, audio, ultraviolet, infrared, spectroscopy, hyperspectral, and optical systems, that collect data without human intervention. These devices may be mounted in fixed positions or on vehicles such as drones or aircraft. Both types of user devices submit their data to the platform's coordinating backend, which is governed by a decentralized blockchain-based architecture to ensure data integrity and immutability.

Another aspect of the invention incorporates data validation and blockchain integration. Once data is captured by user devices, it undergoes a multi-step validation process, including Initial Validation, in which the system cross-references the data with other user device submissions to assess consistency and accuracy. Blockchain Validation, in which data is stored immutably on a blockchain, ensures it cannot be altered or manipulated after submission. AI-Powered Validation, where both decentralized and centralized AI/ML algorithms with databases further analyze the data to check for anomalies, patterns, or correlations with known data entries. Centralized AI supports the continual learning and updating of distributed, decentralized AI while providing additional data and object-identification integrity, enhancing the validation and token valuation processes over time.

Once validated (including authentication), the data is tokenized, and contributors are rewarded with information-based tokens whose value is assessed by the validation steps accomplished to date to speed automatic licensing of the data for commercial and reporting releases. Therefore, these tokens are dynamically valued based on criteria such as the accuracy, consistency, and uniqueness of the data submitted, to name a few. A decentralized governance model allows token holders to influence system upgrades, reward structures, and validation protocols.

The invention, therefore, is an improvement to all event capture systems through its focus on Information Tokenization and Crypto-economic Rewards to incentivize users. Accordingly, the invention determines and assigns value to each issued token. The information token's value is dynamic, meaning it can increase or decrease over time based on ongoing validations, future observations, third parties' interest in purchasing the user's data usage rights, or integrations with third-party systems. For example, factors such as increased validation and cross-platform use ensure dynamic valuation, creating incentives for users to submit accurate, valuable data and contribute to long-term projects that require continuous validation and record updates, thereby enhancing token valuation. More specifically, increased validations relate to the number of user devices that validate a piece of data over time; as its token value increases, cross-platform use enables data to be integrated into external platforms or research systems, further boosting its token value.

Tokenization and the valuation thereof may rely on Governance through a Decentralized Autonomous Organization (DAO). In a preferred embodiment, the inventive platform is governed by a DAO, which allows token holders to participate in decision-making processes with object assessment experts. Key decisions that can be voted on include, for example, (i) adjusting validation criteria to enhance the quality of data submissions and requirements; (ii) altering the reward structures for users, adjusting token distribution algorithms based on user feedback and enhanced authentication (e.g., AI); and (iii) implementing platform upgrades or new features to improve data collection and validation. Each participant's voting power may be proportional to the number of tokens they hold or the object assessment expert's overall ranking, ensuring that contributors who provide the most value have a stronger influence on the platform's future development.

To handle the vast amounts of crowdsourced data, the system employs artificial intelligence (AI) and machine learning (ML) algorithms, as mentioned above. These algorithms continuously learn from data, identifying patterns, detecting false positives, and improving the system's overall prediction accuracy. AI helps the system to recognize emerging trends or anomalies, particularly in recurring or novel UAP sightings, and ensures the commensurate real-time token evacuation. The AI-powered system also assesses the value of data tokens as it processes large datasets, improving the accuracy of information and token values over time. This is critical in situations where users submit data that is validated by future occurrences or ongoing research.

Of course, user anonymity is a core component of the system. While collecting and validating data, user identities are protected through data accuracy checks, encryption, and anonymization protocols for submissions. This too encourages broader participation without fear of reprisal or privacy violations. Regarding tokenization, smart contracts are used to automate token issuance and manage the staking and trading of information tokens. These contracts enable transparent, decentralized transactions, ensuring that users are fairly rewarded for the quality of their contributions. The smart contract system can operate independently and requires no centralized control, ensuring trust and reliability.

Thus, the inventive system also provides a unique mechanism to monetize data through the automated, governed information token model. Users can sell or trade their tokens on the platform, stake them to earn additional rewards, or sell/transfer the underlying copyrights. For example, if a user submits data that is increasingly validated over time, their tokens appreciate in value, and they can stake them to participate in governance or receive higher rewards.

Therefore, the present invention may be summarized as a system for leveraging data gathered by crowdsourcing; protecting user anonymity; utilizing multi-sensor integration; real-time data processing in resident or distributed modes; advanced algorithms (AI, ML, statistical pattern recognition); robust data integrity corroboration; and enhanced location identification techniques to ensure the systematic and unbiased collection and analysis of time-sequenced capture of events; and issuing fungible tokens including value determination and assignment.

In addition, the invention enables and provides the integration of multiple ancillary sensors or independent coordinating relational databases, including visual, infrared, radar, and educational data archives of virtually any type, enabling the collection of diverse data types, which are then processed using, for example, data fusion techniques for comprehensive analysis. The fusion techniques further support the platform's distributed or resident (e.g., cloud-based) real-time data processing.

To ensure data integrity, such as by corroboration, the system employs an authenticator, a discriminator, a comparator, a converter, and a report generator at the data capture and initial processing stages, and advanced security methods such as blockchain storage, checksums for images and metadata, digital signatures if enabled, source-based encryption, certification infrastructure, and a zero-trust security architecture. Additionally, the system enhances location identification by using GPS data augmented with star positioning at night and by processing inclinometer and accelerometer data to triangulate objects using tilt angles from these user device sensors, enabling optional advanced tracking capability.

Furthermore, the system provides flexible integration with existing external relational databases or applications to locate astronomical objects, such as stars and planets, as well as weather phenomena, known aircraft, satellites, meteorites, and space debris, thereby enhancing the accuracy of their identification. The system also optimizes image quality by automatically using raw data formats and adjusting, for example, camera exposure times based on lighting conditions and the phone's inherent memory limitations.

In use, the system identifies and triggers nearby devices (i.e., sends a triggering instruction that is received by the nearby device) capable of participating in crowdsourcing data collection, integrates with stationary sensors such as stationary security camera networks, mono- and bi-static radars, or national emergency signals to provide triggers to user devices for additional crowdsourced data collection, enables real-time communication across multiple potential networks including, for example, but not limited to cellular, Bluetooth, and WiFi or Internet connections for data sharing between user devices. The preferred advanced system provides users and researchers alike with analytical tools to assess and study curated data on unknown objects to support their identification.

The elements of the present inventive platform of the system are software-driven and can be summarized in a variety of ways, including a platform having a transceiver configured to receive a request to capture data associated with Unidentified Anomalous Phenomena (UAP) sighting from a user device; a processor communicatively coupled to the transceiver, wherein the processor is configured to obtain the request from the transceiver; cause the user device to collect UAP data; obtain a trigger from the user device; transmit a notification to other user devices through the central coordination server or an on device friend network of coordinating device identifiers to collect UAP data responsive to obtaining the trigger; receive the UAP data from the user device and the other user devices responsive to the transmission of the notification for data corroboration; authenticate, discriminate, compare, convert, and generate a report of the data; issue tokens and regulate tokenization and the assigned value thereof; and store the UAP data.

Therefore, the various embodiments of the software application driven system also include any or all of the following: a UAP signature generator for generating UAP signatures from collected UAP data; at least one independent relational database capable of storing UAP data signatures; an authenticator for authenticating the collected UAP data before transmitting the notification by accessing at least one coordinating relational database and comparing the UAP data collected by the user device to at least one UAP signature; a discriminator operably connected to the UAP signature generator and at least one coordinating relational database for comparing the authenticated collected UAP data to at least one designated UAP signature within the coordinating-relational database for setting the AI/ML or statistical signature characteristics for distributed or localized processing when the authenticated collected UAP data and corresponding signature differs from the designated signature; a comparator for comparing the signatures from the signature generator of a first user device to the signatures generated by the signature generator of a second user device and comparing the signatures to the stored authenticated UAP data and signatures in at least one coordinating relational database, enabling the system to improve the authentications of the UAP data and the subsequent creation of UAP signatures for any given sequence of UAP data-generating events having a common UAP signature associated with a plurality of users; a report generator for generating an output report of the authenticated collected UAP data and designated signatures received from a plurality of users corresponding to the same UAP event; a converter for converting the reported data into user device manipulation instructions and transmitting those instructions to the users to assist them with the collection of additional UAP data associated with the same UAP sighting event; and tokenization based on a determined value of the data submitted.

The user devices comprising a portion of the system preferably include a camera with adjustable camera settings configured to respond to user device manipulation instructions associated with the authenticated data and designated signatures. In addition, the user processors are configured to initiate the adjustment of the user device camera settings in response to the common authenticated data and the designated signatures, further comprising a UAP signature recognition algorithm capable of calculating signatures corresponding to UAP movement data and generating UAP movement predictions based on the calculations, and initiating responsive adjustments to the camera settings based on the movement predictions. The processors are configured to capture information for local or distributed processing of scene data to better characterize location, look-angle direction, and elevation. Further processing identifies any irrelevant information in the photos/videos and masks it from the uploaded data to help maintain the user's anonymity. (Examples of the user devices include handheld smartphones, portable and desktop computers, to name a few.)

The preferred embodiments also include a tracking function enabling camera adjustments, enabling the user device's camera settings to track UAP movement in accordance with a set of UAP signatures predicting UAP movement. For example, the advanced processor for making movement predictions is operably configured to be responsive to at least one artificial intelligence (AI) algorithm, such that the generated camera adjustments are responsive to non-analogous signatures and authenticated UAP data for an attempt to anticipate typically unpredictable movements of the observed UAP. For example, using Bayesian statistical tracking and posterior prediction algorithms may be a preferred enabling feature. The unpredictable movements become part of a predictable movement signature for a previously recorded UAP sighting event, wherein the unpredictable movement signature is sent to the user devices as an alternative set of tracking data if the observed UAP is no longer visible to any or all users. The user device's camera settings are adjusted to match the received alternate set of tracking information.

A preferred embodiment also includes an advanced report generator (using, for example, large language models/generative AI) to generate a report from the corroborated data and the alternate (additional) set of UAP tracking data when the user device tracking data is authenticated; and a transmitter for transmitting the report to an independently configured responsive system capable of initiating an independent system response commensurate with its function. The reporting function is deemed particularly useful in the context of national security and independently responsive defensive systems.

An advantage of the inventive system is the uniform collection of data, corroborating it, and generating (creating) the data signatures, enabling users and researchers alike to identify variables, behaviors, and characteristics associated with UAP phenomena. In addition, by collecting and analyzing uniform data, the platform facilitates the identification of correlations between UAP sightings and various variables. By providing uniformly captured UAP data, the platform encourages evidence-based discussions and critical thinking while issuing valuable tokens.

A further object and advantage of the inventive platform is that it operates independently while maintaining user anonymity, thereby minimizing denial and obfuscation. The platform focuses on collecting and presenting objective data free from external influences and bias. In addition, the platform reduces ambiguity and confusion, ensuring systematic recording of UAP information for accurate analysis and interpretation. Further, the platform prioritizes privacy and data integrity, safeguarding against manipulation and ensuring the reliability of collected data.

Enhanced Moving Sensor Location Identification. The system utilizes GPS data augmented with a phone's inclinometer and accelerometer when in motion, and with an aircraft's (e.g., airlines and drones) flight information when in flight, to support the integration of an aircraft's flight data. Enhanced sensor location can include surface-to-air linkage that changes if the aerial phenomena are perceived to be moving out of range and defers to an alternate ground-based sensor for primary communication and guidance. This feature may be quite useful in air defense applications where the UAP or airborne object is manmade, “of this earth,” and might be deemed to pose a security threat, and its intended destination is not easily discerned from its detectable in-flight path.

Backend Database and Platform. The preferred system uses a robust backend platform to optimize and facilitate the identification and notification of nearby devices for crowdsourcing and to provide analytical tools for researchers to investigate unknown phenomena. Backend databases and platforms can be used to compile information and generate source predictions, enabling a better understanding of unknown technology from the moment of data capture, based on expectations rather than on close visual inspection. For example, if atmospheric conditions are also measurable from a supporting coordinating relational database standpoint, platform adjustments, such as accommodations for velocity changes or deviations, can be made based on expected path data derived from previously captured signatures, radar data, light reflectance, RF signal feedback, and other conventional identification technologies.

Integration with Stationary Sensors. As mentioned previously, the open network architecture enables integration with stationary sensor networks, security cameras, and mono-static and bi-static radars to provide triggers for crowdsourced data collection. Such integration with stationary sensors may be particularly useful in defensive applications, including national security infrastructure capabilities. For example, given the United States' size, such aspects may be particularly useful because of its large border relative to other nations with relatively small borders, and because identifiable vulnerabilities are contained within a small geographical area. In this way, if multiple ground-based user sensors report and provide observable data for secure systems to respond, the response time and accuracy of the appropriate response, in both strength and means, are better tailored to the situation, and the system is prevented from becoming overwhelmed should multiple events occur at the same time.

Mobility. A significant advantage of the present invention is the unlimited mobility of the open distributed network and the positioning of the sensors, whether ground-based or airborne, such that the guidance of observational sensors for determining the appropriate response and responsive deployments may be correctly integrated, should the need arise. For example, when tracking becomes fragmented or difficult, a UAP may maneuver in a highly unpredictable manner or enter a fluid space with a different density from its previous flight, such as air-to-water submersion. The system is alerted to scan for the UAP pop-up back into the air as an alternate tracking path.

The platform fosters and incentivizes active participation, raises awareness, and reduces the stigma associated with reporting UAP sightings. In addition, the platform advances understanding of UAP phenomena and helps differentiate between mundane/prosaic objects, outlandish informed speculation, and unsubstantiated claims.

These and other features, aspects, objects, and advantages of the present invention will become better understood with reference to the following description.

### BRIEF DESCRIPTION OF THE DRAWINGS

Illustrative embodiments of the present invention are described herein with reference to the accompanying drawings, in which:

FIG. 1 depicts an exemplary environment in which the technique and structure for providing the system and method of the invention;

FIG. 2A-2C depicts a schematic illustrating a process for collecting UAP data via a platform in accordance with embodiments of the invention;

FIGS. 3-6 depict schematic snapshot views of a user interface of a user device, in accordance with embodiments of the invention; and

FIGS. 7A and 7B show the simplified system process flowchart of the present invention.

FIG. 8 is a flow diagram of the platform's architecture, illustrating the flow of data between human-operated and machine-operated user devices and how data is validated on the blockchain.

FIG. 9 is a flow diagram showing the information token generation process, including data submission, validation checks, AI evaluation, and token issuance.

FIG. 10 is a flow diagram of the dynamic token valuation model, illustrating how token value fluctuates due to ongoing validations and integration with third-party systems.

### DETAILED DESCRIPTION OF INVENTION

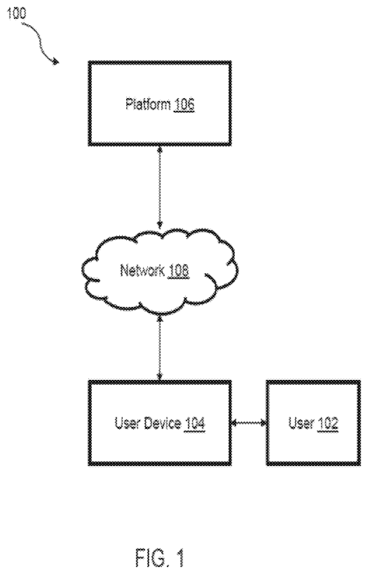

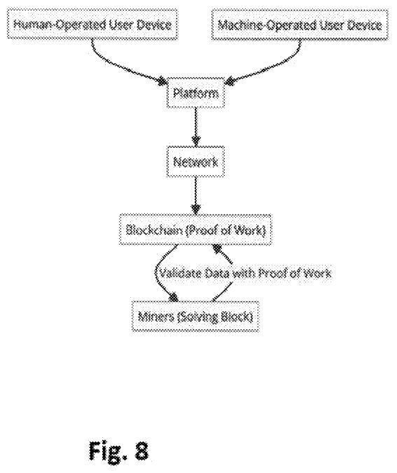

FIG. 1 depicts an example environment 100 in which the techniques and structures disclosed herein may be implemented. Environment 100 includes a user 102 associated with a user device 104. The user device 104 is a mobile phone, tablet, laptop, or similar device with communication capabilities. The user device 104 (human- or machine-operated; see FIG. 8) is communicatively coupled to platform 106 via a network 108. With reference to FIG. 8, the data from the user devices will be sent to the blockchain layer, where data is stored immutably and validated. An AI/ML layer will analyze the data for patterns, accuracy, and validation. After validation, the system will issue information tokens to users based on the data's quality and relevance. Above the blockchain, there will be a DAO governance layer, where token holders can vote on system upgrades, validation criteria, and reward structures.

In a preferred embodiment, platform 106 is an Unidentified Anomalous Phenomena (UAP) sighting platform that facilitates users 102 in capturing data associated with UAP sightings/events. In addition, platform 106 encourages multiple users 102 to participate in the collection of UAP sighting data.

In a preferred embodiment, platform 106 is hosted on a server (not shown) configured to collect crowdsourced visuals and metadata on the UAP. In addition, platform 106 is configured to perform various operations/analyses on the collected data, including, but not limited to, corroboration (e.g., authentication, discrimination, comparison, conversion, signature creation or identification, and report generation); observable event triangulation; bearing intersections; tracking; polling users for validation of anomalous characteristics; and/or the like. Such data collection, corroboration, and operations/analysis enhance the research and understanding of the phenomena.

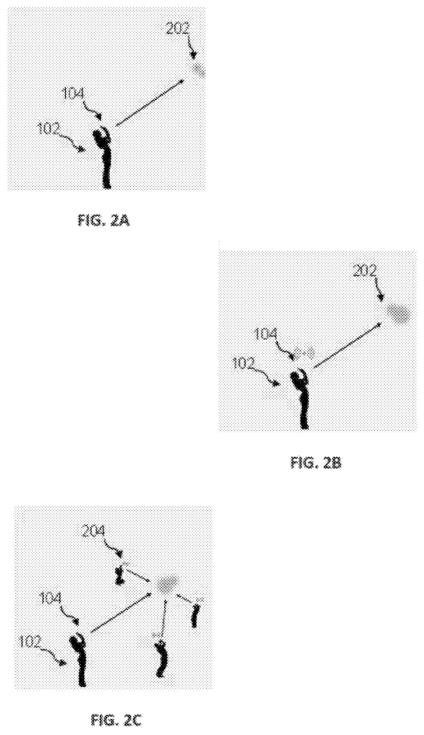

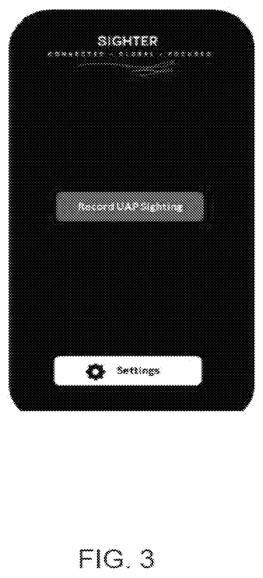

FIGS. 2A-2C depict process 200 to collect UAP data via a platform (e.g., platform 106) in accordance with embodiments of the invention as summarized, described, or claimed herein. FIGS. 2A-2C will be explained in conjunction with FIGS. 3-6. FIGS. 3-6 depict snapshots of a user interface of a user device 104, in accordance with embodiments of the invention.

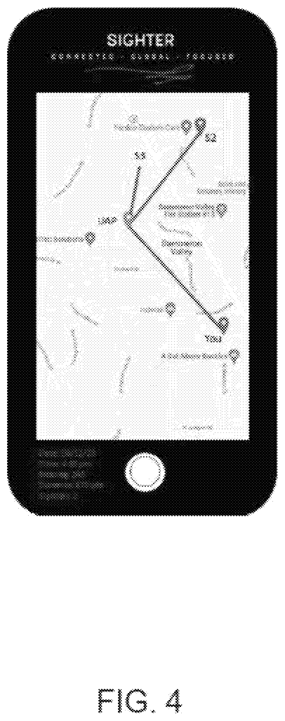

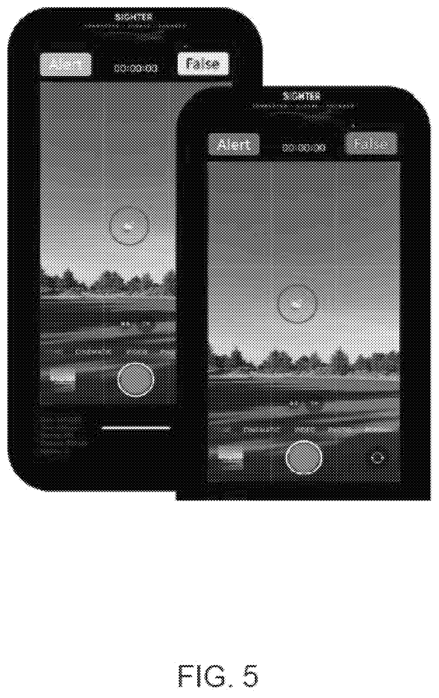

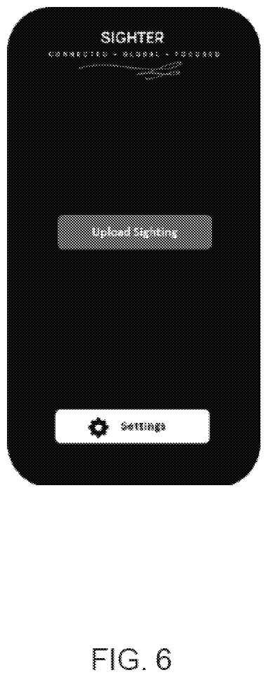

When user 102 detects a UAP 202, user 102 transmits (via the user device 104) a request to platform 106 to capture/record information associated with the UAP sighting (as shown in FIG. 2A and FIG. 3). Platform 106 (e.g., a transceiver of platform 106, not shown) may receive the request. Responsive to receiving the request, platform 106 (e.g., a processor associated with platform 106, not shown) may initiate data collection. In some aspects, platform 106 may collect initial data (via the user device 104) including, but not limited to, photographs, videos, and the azimuth/compass bearing to the UAP 202, video metadata, date, time, and user device location by Global Positioning System (GPS), as shown in FIG. 4. User 102 may then begin to record visual data of the sighting via platform 106 and upload the recording (as shown in FIGS. 5-6). In some aspects, platform 106 (or the processor) may track the estimated direction of travel during any sighting and estimate the distance to the user 102. Platform 106 may then store the captured data and the estimated direction of travel and distance in the memory associated with platform 106. In further aspects, platform 106 (or the processor) may assign a unique identifier (ID) to the sighting.

User 102 initiates transmitting an alert (or a trigger instruction) to the first set of users 204 (via platform 106, as shown in FIG. 2B). The user devices of the first set of users 204 are communicatively coupled to platform 106. Platform 106 is configured to determine/select users that may be located near user 102 (using the location of the user device 104 and proximity/distance to the UAP 202) and transmit the alert/trigger instruction to the selected users (or the first set of users) to collect UAP data. The alert may include information such as distance, bearing, and azimuth data from user 102/user device 1-4. The first set of users 204 may receive the trigger instruction as an alert along the above-mentioned information from user 102 (via respective user devices) and launch platform 106 on their respective user devices and point the respective user devices to the UAP location (as shown in FIG. 2C). The first set of users 204 acquire data associated with the UAP 202 via platform 106 and transmit an alert to a second set of users, creating a swarming effect to capture more data associated with the UAP 202. Platform 106 obtains the data associated with the UAP 202 from user device 104 and user devices associated with the first set of user 204 and stores it in the memory of platform 106.

Platform 106 calculates bearing and distance from the subsequently alerted user(s) to the UAP 202, allowing them to visually acquire the UAP 202. Alerted users may not need to physically move to optimize their sighting unless obstacles obstruct their view. Platform 106 (or the processor of platform 106) assigns each sighting a unique identifier (ID) and is configured to collect UAP data from multiple users (including user 102 and the first set of users 204) to determine the precise location and trajectory of the UAP 202. When platform 106 receives the UAP data from multiple users, it encrypts and analyzes the UAP data store metadata associated with the sightings on a blockchain as a safeguard against post-sighting modification or tampering. Platform 106 may use a sighting reticle on its video recording screen to enhance bearing alignment and create intersections, pinpointing the UAP's location. In a preferred embodiment, the platform 106 polls smartphones' compasses (or user devices' compasses) to obtain shifting bearings during the sighting, synchronizing with the smartphones' clocks. Combining these inputs enables the system to integrate multiple bearings and dynamically reconstruct the UAP's path.

For example, once the UAP distance is determined, the system prompts users to enter the estimated elevation angle of the UAP from their positions (e.g., using simple heuristics). A device-based, third-party API-enabled inclinometer function, incorporated into the system software, automatically measures the elevation angle. The estimated (or directly measured) elevation angle, combined with the distance, allows platform 106 to approximate the UAP's altitude above ground level. In the preferred embodiment, the system authenticates the sighting data and flags non-anomalous sightings. Sightings identified as false positives are kept as references to assist with signature definition and to exclude false positives.

With reference to FIGS. In 7A and 7B, the processing functions associated with the inventive system are disclosed in a list resembling a process flowchart. The associated processing is designated generally by reference numeral 500. (The numerical references contained in the Figures are used for categorization and are not necessarily intended to indicate the processing sequence of the categories unless otherwise indicated or as claimed).

Process flow 500 outlines the core system's comprehensive steps, from initial data captured by user devices to final reporting and system improvements. It emphasizes the system's ability to leverage crowdsourced data, ensure data integrity through corroboration (not shown), and utilize advanced algorithms to analyze and authenticate sightings. It is to be understood as permitting simultaneous (parallel) processing, as well as distributed or cloud-based processing, based on several functions limited only by the system hardware capabilities, process logic, and security requirements that require sequential processing.

Concerning User Device Interaction. The process begins when a user or an automated user device identifies an unknown airborne object or UAP (Unidentified Anomalous Phenomena). The user or an automated user device sends a trigger to the system's platform, which then identifies and sends a trigger to other user devices in the local area. The user or an automated user device initiates a request to capture all relevant data (images, videos, GPS coordinates, sensor data, and metadata) using the device's sensors (e.g., a smartphone, tablet, or other device). Captured data is optimized by the device's processor for transmission back to the system's platform and correlated with a unique timestamp and location ID for further processing. A user device notifies, via a trigger, that an airborne object or UAP is in the area. The initiating user device sends a request to capture all relevant data (images, videos, GPS coordinates, sensor data, and metadata) after the user observes the object (e.g., a smartphone, tablet, or other device). Captured data is optimized by the device's processor for transmission back to the system's platform and correlated using a unique timestamp and location for further processing.

Concerning Data Collection by the Transceiver. A signal request is received from, but not limited to, the mobile phone network, WiFi, the internet, or Bluetooth by a transceiver in the system, which triggers a user device to automatically start collecting all relevant data (images, videos, GPS coordinates, sensor data, and metadata) for that device. The transceiver ensures that all relevant data (images, videos, GPS coordinates, sensor data, and metadata) are captured from the user device and sent to the processor for further operations. The processor uses an on-device database of attached sensors and device capabilities with optimal configuration settings.

The preferred processor enables all attached sensors with the optimal configuration and collects all relevant data (images, videos, GPS coordinates, sensor data, and metadata). All relevant collected data (images, videos, GPS coordinates, sensor data, and metadata) are then sent to the user device's on-device processor. The processor performs initial data processing, including data filtering, format conversion, authentication, discrimination, and preparation for further analysis. If the initial data processing determines that the airborne object or UAP sighting is of interest, the processor sends a notification to nearby user devices via the system's backend platform, prompting them to begin collecting additional data. Data processing is distributed and shared.

The preferred processors use the on-device database of optimal configuration settings to determine if the on-device processor is capable of advanced algorithmic processing. If capable, advanced AI/ML and other algorithms, such as statistical image processing, pattern matching, Bayesian analysis, and others, analyze the aggregated data, verify the authenticity of the sighting, and classify the object or phenomenon as known or unknown. This includes comparing the data with existing “signatures” stored in other databases. Once the relevant data is processed, the processor identifies an optimal schedule for transceiver transmission operations. Once the relevant data is processed, a cryptographic co-processor performs Data Checksum and Encryption operations.

Concerning Data Checksum and Encryption (Data Security). Cryptographic methods such as full data encryption or cryptographic checksums, using any of the various cryptographic approaches, or digital signatures are applied, for example, to all the relevant data or just the data's checksum value and then encrypted to ensure that the validity of the data remains secure and unchanged.

Concerning Data Transmission by Transceiver. The transceiver ensures that all relevant data (images, videos, GPS coordinates, sensor data, and metadata) are scheduled for optimal, timely transmission from the user device to the system processor for subsequent processing. If the user device triggers additional local devices, only the minimal relevant data is sent to the system processor as quickly as possible.

Concerning System Data Aggregation and AI/ML Analysis. The system processor prioritizes triggering requests for other devices' participation based on minimal location information from the requesting user device. The system processor aggregates data from multiple user devices based on a unique event, creating a comprehensive dataset for further processing. The integrity of processor-aggregated data from multiple user devices is verified using, for example, a public-key data integrity infrastructure to confirm the authenticity of the user device and the captured data.

Signatures in other online data providers can include, but are not limited to, matching triangulated location information with online aircraft and satellite location data from other online data providers, correlating electromagnetic radiation and other signatures, such as from an object's ‘blinking’ pattern and other captured sensor data, including but not limited to spectrometers, GPS, magnetometers, and others.

Concerning Relational Database Comparison. The processed data is compared against signatures in the resident and independent relational databases. This step is crucial for authenticating the sighting and ensuring data integrity. If the data does not match any existing signatures, a new data signature is created and added to the database, enriching the system's knowledge base. These signatures, with a high probability of being of unknown origin, are immediately flagged and reported to system administrators and data analysts for further analysis.

Concerning Data Storage and Encryption (Data Security). The verified and processed data, along with any new signatures, are stored securely, preferably using blockchain technology, to document data access requests and processing performed and to prevent tampering. Cryptographic methods such as checksums and digital signatures are used to ensure that data remains secure and unchanged in storage.

Concerning Reporting and Feedback. The system generates reports based on the analyzed data, including predictive analytics of the object's behavior. These findings, along with any relevant findings, are transmitted back to the original user and other participating users. Additionally, the system might send feedback or instructions for further data collection or monitoring.

Concerning Continuous Learning and System Improvement. The system continuously improves by integrating new data and feedback loops, refining its AI/ML and other algorithmic models for identification and data processing to enhance future analytical capabilities.

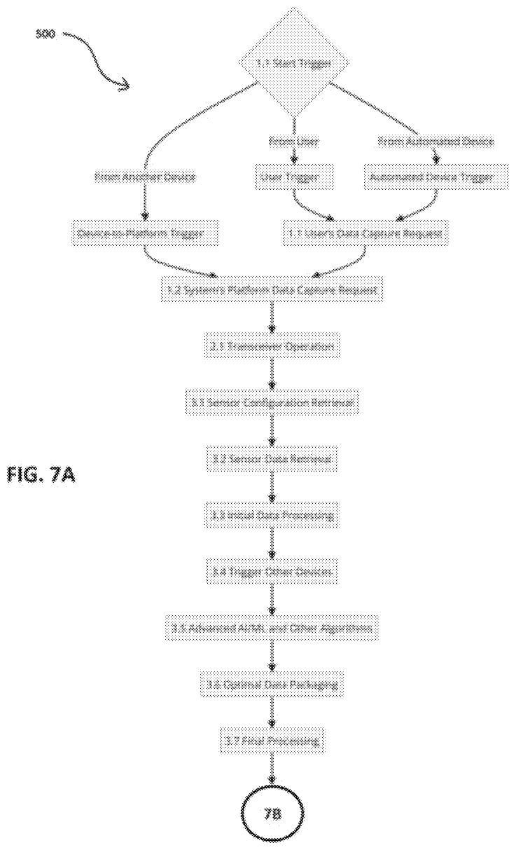

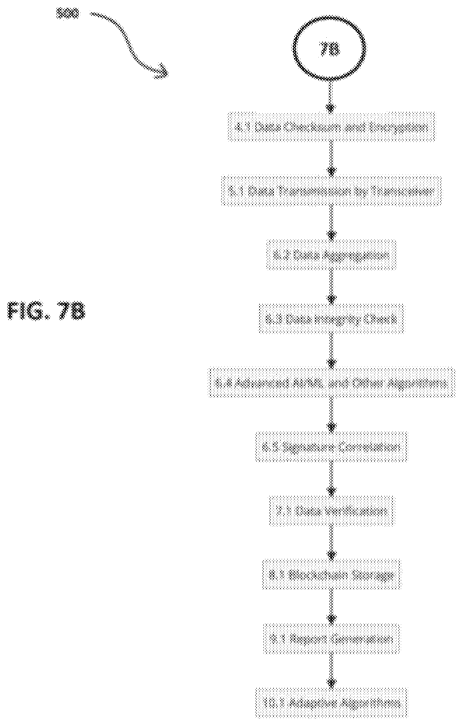

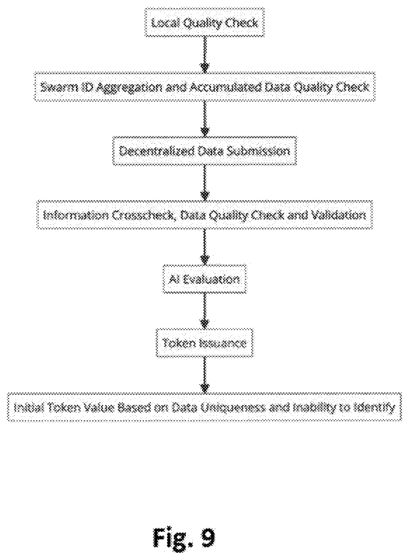

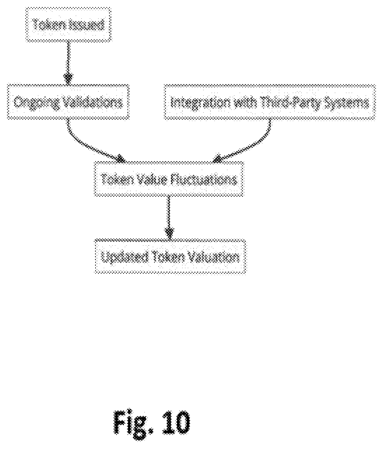

With reference to FIGS. 7A, 9, and 10, the inventive system determines (“information tokenization”) and assigns (“dynamic value assignment”) tokens for validated (authenticated) submissions. These and other embodiments of the present invention, as set forth in the preceding description, are contemplated to be within the scope of the present invention, which is limited only by the appended claims. A few examples are provided.

What is claimed is:

1. A software application driven system comprising:
a transceiver configured to receive a request to capture data associated with Unidentified Anomalous Phenomena (UAP) sighting from a user device; and
a processor communicatively coupled to the transceiver, wherein the processor is configured to:
obtain the request from the transceiver;
cause the user device to collect UAP data;
obtain a trigger from the user device;
transmit a notification to other user devices to collect UAP data responsive to obtaining the trigger;
receive the UAP data from the user device and the other user devices responsive to the transmission of the notification and store the UAP data;
a crypto-economic system for incentivizing user participation by issuing tokens based on the value of validated data contributions; and
issuance of an information token that is dynamically valued based on the inherent value of the validated data, wherein the value is determined by predefined validation criteria, including accuracy, consistency, and uniqueness of the information.

2. The system of claim 1, further comprising:
a UAP signature generator for generating UAP signatures from collected UAP data;
at least one coordinated relational database capable of storing information for validating UAP data signatures, and
an authenticator for authenticating the collected UAP data before transmitting the notification by accessing the at least one relational database and comparing the UAP data collected by the user device to at least one UAP signature and assigning a value to a token.

3. The system of claim 2, further comprising:
a discriminator operably connected to the UAP signature generator and the at least one relational database for comparing the authenticated collected UAP data to at least one designated UAP signature within the relational database and initiating the creation of a new UAP signature when the authenticated collected UAP data and corresponding signature differ from the designated signature;
a comparator for comparing the signatures from the signature generator of a first user device to the signatures generated by the signature generator of a second user device and comparing the signatures to the stored authenticated UAP data and signatures in the at least one relational database, enabling the system to improve the authentications of the UAP data and the subsequent creation of UAP signatures for any given sequence of UAP data-generating events having a common UAP signature associated with a plurality of users and adjust the assigned value of the token.

4. The system of claim 3, further comprising:
a report generator for generating a report of the authenticated collected UAP data and designated signatures received from a plurality of users corresponding to the same UAP event;
a converter for converting the reported data into user device manipulation instructions and transmitting those improvement instructions to the users to assist them with the collection of additional UAP data associated with the same UAP sighting event, and adjusting the previously assigned value of the token based on those instructions.

5. The system of claim 4, wherein the user device includes a camera with adjustable camera settings configured to be responsive to the user device manipulation instructions associated with the authenticated data and designated signatures, wherein the processor is configured to initiate the adjustment of the user device camera settings in response to the common authenticated data and the designated signatures, further comprising:
a UAP signature recognition algorithm capable of calculating signatures corresponding to UAP movement data and generating UAP movement predictions based on the calculations, and triggering responsive adjustments to the camera settings based on the movement predictions.

6. The system of claim 5, further comprising:
a tracker, for producing tracking data responsive to the camera adjustments, enabling the user device camera settings to track UAP movement in accordance with a set of UAP signatures for predictable UAP movements.

7. The system of claim 5, wherein:
the processor for making movement predictions is operably configured to be responsive to at least one artificial intelligence (AI) algorithm such that the generated camera adjustments are responsive to non-analogous signatures and authenticated UAP data to anticipate unpredictable movements of the UAP being observed and the unpredictable movements become part of the predictable movement signatures for a previously recorded UAP sighting event wherein the unpredictable movement signature is sent to the user devices as an alternate set of tracking data if the observed UAP is no longer visible to any of the users; and
the user device camera settings and token value are adjusted to correspond to the alternate set of tracking data received.

8. The system of claim 1, wherein:
the report generator generates a token valuation report from the alternate set of tracking data when the user device UAP tracking data is authenticated as capable of tracking the UAP; and
transmits the token valuation report to an independently configured responsive system capable of initiating an independent system response commensurate with its function.

9. The system claim 8, wherein the independent system response is generated from a blockchain-based validation system that ensures the immutability of the data collected by the user devices to verify the assigned value of the token.

10. The system of claim 9, wherein the blockchain-based validation system further comprises:
a decentralized autonomous organization (DAO) that governs a set of system policies, a set of reward structures, and platform upgrades through community-driven voting mechanisms.

11. The system of claim 9, wherein the blockchain-based validation system further comprises:
an artificial intelligence (AI) and/or machine learning (ML) algorithm for analyzing data, identifying patterns, and continuously improving validation processes and token value assessments, and the token assignment issued therefrom.

12. An improvement to a cell phone apparatus for capturing UAP information of the type claimed in U.S. Pat. No. 12,468,754 wherein the improvement comprises:
at least one coordinated relational database capable of storing information for validating UAP data signatures,
a crypto-economic system for incentivizing user participation by issuing at least one token based on a determined value of validated data contributions associated with the information packet, and an
an authenticator for authenticating the collected UAP data before transmitting the notification by accessing the at least one relational database and comparing the UAP data collected by the user device to at least one UAP signature and assigning a value to the at least one token.

13. The improved apparatus of claim 12, wherein the crypto-economic system further comprises:
a cryptocurrency module for creating and issuing a cryptocurrency token uniquely associated with a corresponding information packet that is dynamically valued based on the inherent value of the validated data, wherein the value is determined by predefined validation criteria, including accuracy, consistency, and uniqueness of the information.

14. An improvement to a cell phone apparatus for capturing UAP information of the type claimed in U.S. Pat. No. 11,037,024 wherein the improvement comprises:
at least one coordinated relational database capable of storing information for validating UAP data signatures,
a crypto-economic system for incentivizing user participation by issuing at least one token based on a determined value of validated data contributions associated with the information packet, and an
an authenticator for authenticating the collected UAP data before transmitting the notification by accessing the at least one relational database and comparing the UAP data collected by the user device to at least one UAP signature and assigning a value to the at least one token.

15. The improved apparatus of claim 14, wherein the crypto-economic system further comprises:
a cryptocurrency module for creating and issuing a cryptocurrency token uniquely associated with a corresponding obtained combination of objects and/or the obtained events of interest that is dynamically valued based on the inherent value of the validated data, wherein the value is determined by predefined validation criteria, including accuracy, consistency, and uniqueness of the information.
